(19) United States
(12) Patent Application Publication
(10) Pub. No.: US 2017/0172205 A1
(43) Pub. Date: Jun. 22, 2017

(54) OXIDATION VAPORIZER

(71) Applicants: Joe Chang, Carbondale, IL (US); Wael Mostafa Elshaer, Cairo (EG)

(72) Inventors: Joe Chang, Carbondale, IL (US); Wael Mostafa Elshaer, Cairo (EG)

(21) Appl. No.: 14/975,711

(22) Filed: Dec. 18, 2015

(51) Int. Cl. A24F 47/00; H05B 3/42; F22B 1/28

(52) U.S. Cl. CPC A24F 47/008; A24F 47/006; F22B 1/284; H05B 3/42

(57) ABSTRACT

E-cigs are on the market more than 10 years, most smokers tried it and keep smoking cigarettes because 99% smokers cannot get satisfaction from vaping due to inhaling not oxidized nicotine vapor, people been smoking for 5 thousand years, put tobacco in pipe/cigs and burn/combust it to get buzz, the active ingredient in the inhaled tobacco smoke is oxidized nicotine. after scientist and doctors discovered cigarette smoking causing cancers and vaping then invented to prevent inhaling harmful smoke produced by combustion of the tobacco plant material, but vaping cannot satisfy smokers due to vaping cannot producing oxidized nicotine as smoking does. The better/new/best/correct way to get nicotine buzz is oxi vaping by inhaling oxidized nicotine vapor because it tastes better, give better buzz, and use less material, due to combustion destroys some of the nicotine or thc in the plant material, vaping takes all nicotine or thc from plant material but not oxidized, it is not harmful as smoking but it cannot give smoking buzz. oxi vaping, takes all nicotine or thc from plant material and oxidize it, so smokers get great taste and buzz but use less material as smoking or vaping.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates generally to vaporization devices. More particularly, the present invention relates to a oxidation vaporizer designed to provide oxidized nicotine vapor by using a dual chamber and a heat source.

Description of the related art.

I am a heavy smoker and I started vaping four and half years ago, my lungs got healthier right away. Before I started vaping or use the present invention I was coughing all day, my lungs were hurting and I would cough up chunk of dark go every few minutes.

After I found out vaporizers are not very convenient, I invented vaporization lighter (U.S. Pat. No. 8,490,631) and use it to vaporize since. I learned vapor is much cleaner than smoke therefore healthier, so I set my goal to invent a tool to vaporize cigarette, because cigarette smoking kills and I like to save lives. Last years I finally invented the cigarette vaporizer and filed for it a provisional patent application No. 62/067,267. During my vaping experience, I also learned vaping buzz is not as good as smoking buzz, I always miss the smoking buzz. Then I theorized and discovered nicotine vapor contains not oxidized nicotine, tobacco smoke contains oxidized nicotine. So I invented a method and a tool to produce oxidized nicotine called oxidation vaporizer, it contains two chambers and two heat sources, put tobacco in a vaporization chamber and heat it to nicotine's boiling point to produce nicotine vapor, then transfer the nicotine vapor to an oxidation chamber and heat it to flash point to produce oxidized nicotine vapor. After I invented the cigarette vaporizer, use it to vaporize tobacco for some time, one day I discovered that I can heat the rear part of the brass tube to higher temperature to oxidize tobacco vapor without combustion tobacco in the front part, and the oxidized vapor tastes great and gives awesome buzz, solution was found, dual chamber one heat source oxidation vaporizer.

Vaporization provides many benefits over smoking. But 99% smokers are still smoking after tried electronic cigarettes. The main reason is smoking inhaling oxidized nicotine due to combustion of the tobacco, vaping inhaling not oxidized nicotine without combustion. The two different chemical compounds affect smoker differently. Oxidized nicotine vapor is much more addictive than not oxidized nicotine vapor.

It would be an advance in the art of vaporization devices to provide a oxidation vaporizer that produces oxidized vapor, is inexpensive, is small and is simple to operate. Such a device could be widely used by tobacco smokers and by users of medicinal herbs. Such a device would also largely convert smokers quit smoking and start vaping to live healthier lives.

### BRIEF SUMMARY OF THE INVENTION

In one aspect the present invention can satisfy smokers due to vaping can producing oxidized nicotine as smoking does, The present invention is the best way to get nicotine buzz by inhaling oxidized nicotine vapor because it tastes better, give better buzz, and use less material, due to combustion destroys some of the nicotine or thc in the plant material, vaping takes all nicotine or thc from plant material but not oxidized, it is not harmful as smoking but it cannot give smoking buzz. oxi vaping, takes all nicotine or thc from plant material and oxidize it, so smokers get great taste and buzz but use less material as smoking or vaping.

### DESCRIPTION OF THE DRAWINGS

For a more complete understanding of the present invention, reference is now made to the following descriptions:

FIG. 1 Shows a cross-sectional side view of a oxidation vaporizer powered by a heating coil according to the present invention.

FIG. 2 Shows a cross-sectional side view of a oxidation vaporizer powered by a flame according to the present invention.

### REFERENCE NUMERALS IN THE DRAWINGS

For a more complete understanding of the present invention parts, reference is now made to the following descriptions:

1—Brass dual chamber tube including front part as vaporization chamber and rear part as oxidation chamber.

2—vaporization chamber.

3—The neck.

4—The oxidation chamber.

5—The glass mouth piece that fiction connected to the brass dual chamber.

6—Tobacco.

7—The vapors of tobacco pass the rear part of the dual chamber.

8—The vapors of tobacco exit into the mouth piece then inhaled by user.

9—Heat source can be flame or coil.

9A—Coil.

9B—Flame.

10—Battery and pipe holder.

11—battery.

12—On/off/current/voltage control.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

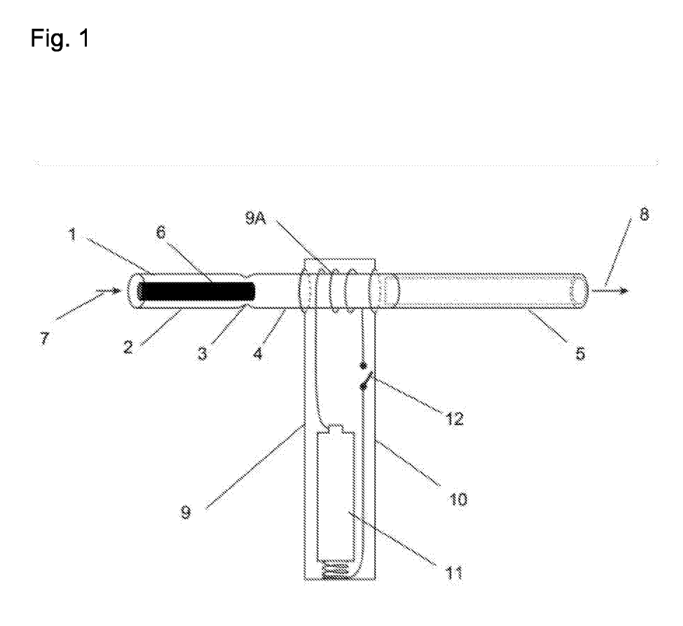

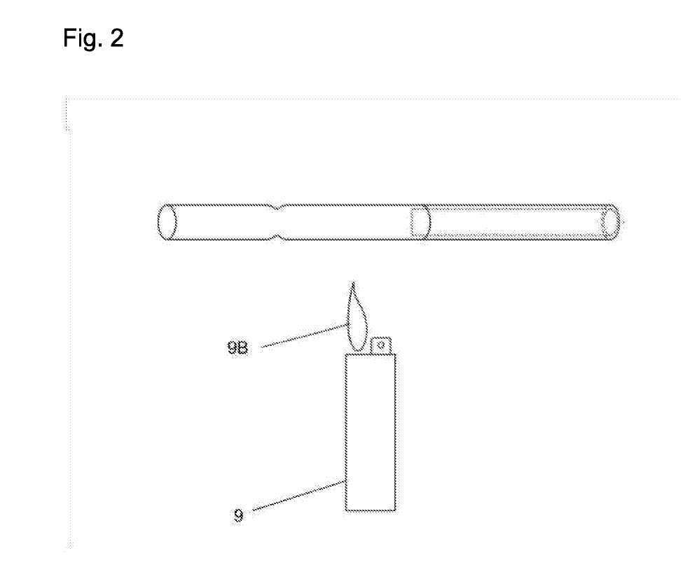

Referring to FIG. 1 the present invention includes basically a glass mouth piece 5 and a brass dual chamber made by high thermal conductivity metal tube 1, the brass dual chamber tube 1 including front part as vaporization chamber 2 and rear part as oxidation chamber 4, in the middle between vaporization chamber 2 and oxidation chamber 4 there is a neck 3. The glass mouth piece 5 connects to the rear end of the brass dual chamber tube 1. There is a heating source 9 that consists of coil 9A, battery and pipe holder 10, battery 11 and on/off/current/voltage control 12, also the heat source can be depends on flame 9B as explained in FIG. 2.

Referring to FIG. 1 so we can use the present invention we will follow the following steps:

The tobacco 6 is load in the front part of the dual chamber that is the vaporization chamber 2, a user heat the rear part of the dual chamber that is the oxidation chamber 4 to nicotine's flash point, so that the heat conducts to the front part of the dual chamber that is the vaporization chamber 2 is lower than flash point and able to vaporize tobacco 6 without combustion it, the vapors of the tobacco 6 pass the rear part of the dual chamber (that is oxidation chamber 4) 7 are oxidized at flash point and exit into the mouth piece 5 then inhaled by user 8. If user wants not oxidized nicotine vapor, simply heats the dual chamber 1 at a temperature that is under tobacco's flash point.

1. The method for producing oxidized active ingredients within herbs and plants vapors using a dual chamber which contains a front part as vaporization chamber and a rear part as oxidation chamber and one heat source to heat the oxidation chamber to active ingredients flash point to produce oxidized vapors and the heat conducted to the vaporization chamber to heat herbs and plants to active ingredients boiling point to produce vapors.

2. An apparatus for vaporizing and oxidizing herbs and plants comprising: a dual chamber, which contains a front part as vaporization chamber and a rear part as oxidation chamber, and a mouth piece; the oxidation chamber can be heated by a coil or flame; the herbs and the plants are placed within the vaporization chamber; so that when the herbs and plants are heated by the vaporization chamber to boiling point to form vapors, and the vapors are heated by the oxidation chamber to flash point to form oxidized vapors, the oxidized vapors from the herbs and the plants are able to exit through the mouthpiece.

3. An apparatus for vaporizing and oxidizing herbs and plants comprising: a housing, which contains a dual chamber which contains a front part as vaporization chamber and a rear part as oxidation chamber, and a power source and an activation button for the power source; the oxidation chamber has a heating element, which is connected to the power source; the herbs and the plants are placed within the vaporization chamber; a mouth piece engages the oxidation chamber; so that when the herbs and plants are heated by the vaporization chamber to boiling point to form vapors, and the vapors are heated by the oxidation chamber to flash point to form oxidized vapors, the oxidized vapors from the herbs and the plants are able to exit through the mouthpiece.

4. In claim 2 and claim 3 the dual chamber has a reduction in the middle part, so that the herbs and plants are easier to load into the vaporization chamber without entering the oxidation chamber, and the heat from the oxidation chamber is easier to conducting to the vaporization chamber.

5. The activation button in claim 3 can adjust resistance therefore able to control heating temperature.

6. The dual chamber in claims 1, 2, 3, 4 and 5, is made by high thermal conductivity material such as aluminum, brass, gold and silver.

7. Use 2 heat sources to heat vaporization chamber and oxidation chamber separately in claims 1 to 6.

8. Use glass tube to make 1 piece oxidation vaporizer.
